(19) United States
(12) Patent Application Publication
(10) Pub. No.: US 2016/0127466 A1
(43) Pub. Date: May 5, 2016

(54) METHODS AND SYSTEMS FOR PROVIDING CONTENT DATA TO CONTENT CONSUMERS

(71) Applicant: Rosetta Marketing Group, LLC, Hamilton, NJ (US)

(72) Inventors: Johannes Albrecht, Strongsville, OH (US); Christopher Hayden Baran, Rocky River, OH (US); Sean Edward Boulter, Fairview Park, OH (US); Zachary Stephen Bussinger, Akron, OH (US); Shawn Scott Cornelius, Strongsville, OH (US); Ernest R. D'Amato, III, Kirtland, OH (US); Michael Richard Stack, Lakewood, OH (US)

(21) Appl. No.: 14/527,471

(22) Filed: Oct. 29, 2014

(51) Int. Cl. H04L 29/08; G06F 17/30

(52) U.S. Cl. CPC H04L 67/1097; G06F 17/30595; H04L 67/32

(57) ABSTRACT

An automated content extraction, transformation, and load (ETL) system extracts content from a source content system, transforms the content, loads the transformed content into a specific target system, and then allows a content consumer to search, request, and receive content data without communicating with the source content system. The system may retrieve content data of any type from one or more content delivery management (CMS) repositories using CMS connectors. The system then may extract content from the retrieved content items and may provide the extracted content items to a search platform for indexing. The system may extract the one or more content assets and store the extracted assets into a content delivery network (CDN), for example without communicating or accessing any of the CMS repositories.

### FIELD OF INVENTION

This disclosure generally relates to content management, and more specifically, to automatically retrieving content items of any type residing within a content management system repository, converting the content items into a uniform searchable format, and providing the content items to a content consumer via a search platform and/or content delivery network.

### BACKGROUND

An eCommerce platform allows a customer to interact with a retail store or a wholesaler in purchasing goods or services via the Internet. Early on, eCommerce platforms were designed to manage limited amounts of structured data, such as customer information, product information, order information, etc. However, retailers quickly desired more content rich media on their eCommerce sites that was unstructured and generally not supported by these traditional eCommerce platforms. In response, developers began utilizing separate content management systems (CMS) or digital asset management systems to handle this more desired media rich, unstructured data content, such as documents, filed-based content, etc.

A CMS may be used in a wide variety of applications, including managing content for websites that may contain blogs, news, or products for sale or organizing documents, contacts, records, etc. related to the processes of a commercial enterprise. Specifically, a CMS may store web content in a content repository and may allow a user to publish, to edit, and to modify the content for deployment on a web page. This content repository may contain a wealth of content information, such as page content, textual content, images, videos, file-based content, embedded graphics, metadata, and other information assets. In addition to storage, a CMS may manage the delivery of content to requesting users by searching the content repository and serving the requested content.

Additionally, web designers and organizations desired to manage and to provide even more immersive, content rich eCommerce experiences for their users and customers, and as a result, web content management platforms (WCM) have proliferated. A user with little knowledge of web programming languages is capable of authoring, collaborating, and managing editorial web content via one of many WCM platforms with relative ease. However, similar to the plurality of different schemas that may be implemented for a CMS, each WCM platform may also store and organize content in a number of different schemas, structures, etc. Because content providers are using increasingly different schemas, unstructured data, and proprietary WCM platform protocols, it remains difficult to website developers to integrate content from many sources in developing a eCommerce website.

### SUMMARY

A computer-implemented method for automatically providing content items of any type stored within a content management system (CMS) repository to a content consumer via a content delivery network (CDN) retrieves, via a CMS connector, a plurality of content items from a CMS repository, each content item being of any type and the CMS connector being configured to access each content item of any type stored within the CMS repository. The method extracts content and one or more content assets from each retrieved content item an provides each of the one or more extracted content assets for each content item to at least one CDN for storage, each extracted content asset capable of being retrieved via an unique uniform resource identifier (URI) that indicates the storage location of the particular extracted content asset within the CDN, the CDN configured to provide one or more content assets in response to receiving a corresponding one or more unique URIs without communicating with the CMS repository. The method also provides i) the extracted content and ii) the unique URI associated with each of the plurality of retrieved content items to a search platform, the search platform configured to provide content and one or more unique URIs associated with the CDN in response to a consumer initiated content request without communicating with the CMS repository.

In another embodiment, a computer readable medium having instructions stored thereon and executable by one or more processors, performs a method of automatically providing content items of any type stored within a content management system (CMS) repository to a content consumer via a content delivery network (CDN) retrieves, via a CMS connector, a plurality of content items from a CMS repository, each content item being of any type and the CMS connector being configured to access each content item of any type stored within the CMS repository. The method extracts content and one or more content assets from each retrieved content item and provides each of the one or more extracted content assets for each content item to at least one CDN for storage, each extracted content asset capable of being retrieved via an unique uniform resource identifier (URI) that indicates the storage location of the particular extracted content asset within the CDN, the CDN configured to provide one or more content assets in response to receiving a corresponding one or more unique URIs without communicating with the CMS repository. The method also provides i) the extracted content and ii) the unique URI associated with each of the plurality of retrieved content items to a search platform, the search platform configured to provide content and one or more unique URIs associated with the CDN in response to a consumer initiated content request without communicating with the CMS repository.

In yet another embodiment, a system for automatically providing content items of any type stored within a content management system (CMS) repository to a content consumer via a content delivery network (CDN) include a CMS connector capable of being communicatively coupled to a CMS repository. The system additionally includes a content convertor communicatively coupled to the CMS connector that is configured to retrieve, via a CMS connector, a plurality of content items from a CMS repository, each content item being of any type and the CMS connector being configured to access each content item of any type stored within the CMS repository and to extract content and one or more content assets from each retrieved content item. The content convertor is configured to provide each of the one or more extracted content assets for each content item to at least one CDN for storage, each extracted content asset capable of being retrieved via an unique uniform resource identifier (URI) that indicates the storage location of the particular extracted content asset within the CDN, the CDN configured to provide one or more content assets in response to receiving a corresponding one or more unique URIs without communicating with the CMS repository. The content convertor is further configured to provide i) the extracted content and ii) the unique URI associated with each of the plurality of retrieved content items to a search platform, the search platform configured to provide content and one or more unique URIs associated with the CDN in response to a consumer initiated content request without communicating with the CMS repository.

### BRIEF DESCRIPTIONS OF THE DRAWINGS

FIG. 1 is a high-level block diagram of a computing environment that implements an automated content extraction, transformation, and load (ETL) system that allows a content consumer i) to request content items from one or more content management system (CMS) repositories using a single search platform and ii) to receive the requested content assets via a content delivery network (CDN);

FIG. 2 illustrates an example routine or process flow diagram for automatically retrieving content items of any type residing within a CMS repository, converting the content items into a uniform searchable format, and providing the content items to a content consumer via a search platform and/or CDN; and

FIG. 3 illustrates an example routine or process flow diagram for automatically retrieving content items of any type residing within a CMS repository, converting the content items into a searchable target based uniform resource identifier (URI) content item, and providing the searchable target based URI content items to a content consumer via a search platform and/or CDN.

### DETAILED DESCRIPTION

Generally speaking, an automated content extraction, transformation, and load (ETL) system extracts content from a source content system, transforms the content, loads the transformed content into a specific target system, and then allows a content consumer to search, request, and receive content data without communicating with the source content system. For example, the automated content ETL system may retrieve content data of any type from one or more content delivery management (CMS) repositories using one or more corresponding CMS connectors that are specifically implemented to access and to retrieve content data for a particular type of CMS repository. The system then may extract content from the retrieved content items into a searchable, uniform format that may be easily searched and may provide the extracted content items to a search platform for indexing. In response to determining the presence of an embedded content asset within or associated with a particular content item, the system may extract the one or more content assets and store the extracted assets into a content delivery network (CDN), for example. Furthermore, the system may assign, for example, an unique uniform resource identifier (URI) for each extracted content item that indicates the storage location of the content asset in the CDN. Additionally, the search platform may store/index both i) the unique URI of the content asset and ii) the corresponding extracted content of a particular content item together in the search platform. As a result, in response to receiving a consumer initiated request for content or a content asset, the search platform may query a search index, for example, and provide not only the stored content but also the unique URI of the content asset associated with the request without communicating with any the CMS repositories. In turn, the consumer may use the received unique URI to request the associated content asset store in the CDN at the location indicated in the URI, again, without communicating or accessing any of the CMS repositories.

Advantageously, this configuration of the automated content ETL system allows content authors or creators to work with one desired or preferred type of CMS repository to create and to store content in that one CMS repository. Because the automated content ETL system may access content items from any type of CMS repository, extract/transform/convert the content items, and load the content items into a single target source, each content creator may beneficially work with her desired type of CMS repository. Moreover, any extracted content assets, including unstructured data types, may be stored at a location within a CDN and may be accessed via an unique URI that may be stored or indexed with a search platform. Beneficially, this indexing content and content asset URIs on a search platform and accessing content assets stored in the CDN of the system allows for many uses of data for a diverse group of content client consumers including eCommerce platforms, mobile applications, native applications, or any consumer that may utilize a REST-based, search interface. In addition, the automated content ETL system allows for a disconnect architecture so that the one or more CMS repositories are fully decoupled from content delivery and are able to be lightly maintained by content authors (i.e., non-engineers, etc.) Moreover, a content author need not worry about the problems of increased traffic, scalability issues, etc. because the ETL system prevents traffic from accessing the CMS repository. In turn, the system allows a developer to scale the search platform and CDN to an appropriate production level which makes the entire content delivery system more efficient and robust by allowing the placement of content and content assets into edge-caching servers, etc. Moreover, this disconnected nature between the source system and target system improves the security of the content items stored in the source system.

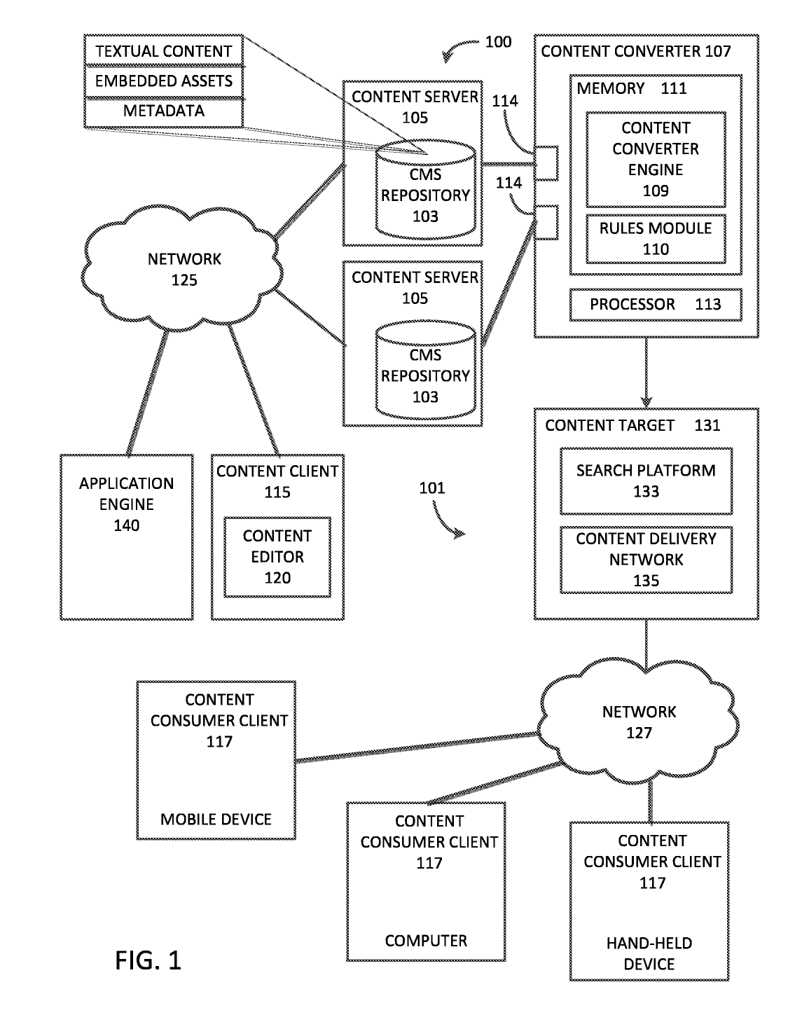

FIG. 1 is a high-level block diagram that illustrates a computing environment for a content editing system 100 and an automated content ETL system 101 that may be used to retrieve content items residing in one or more CMS repositories 103, to transform or convert the retrieved content items into a searchable target based format, and to provide the converted content items to a search platform and CDN for delivery to a requesting content consumer. The automated content ETL system 101 includes a content converter 107 that is communicatively coupled to a content target 131, which in turn, is connected to a number of content consumer clients 117 through a communication network 127. The content converter 107 may be, for example, implemented in a server having a processor 113, a memory 111, a computer readable medium or storage unit (not shown) of any desired type or configuration, and one or more CMS connectors 114 for accessing content data with the CMS repositories 103. The memory 111 may store an content converter engine 109 (and an associated rules module 110) that communicates with the content target 131. The content target 131 includes a search platform 133 that communicates with the CDN 135 which is configured to deliver content to one or more of the content consumer clients 1117. Each content consumer client 117 includes a processor (not shown) and a computer readable memory (not shown) that may execute a browser or anything other application that may request content from the content target 113. Any particular content consumer client 117 may be connected to or may be disposed within a user interface device (not shown) that may be for example, a hand-held device, such as a smart phone or tablet computer, a mobile device, such as a mobile phone, a wearable mobile device, a computer, such as a laptop or a desktop computer, or any other device that allows a user to interface using the network 127. Any particular content consumer client 117 may also be connected to or may be disposed within a content editor 120 (discussed below). While only three content consumer clients 117 are illustrated in FIG. 1 to simplify and clarify the description, it is understood that any number of content consumer clients 117 are supported and can be in communication with the content converter 107.

The content editing system 100 includes one or more content servers 105 that are connected to a content client 115 through a communication network 125. A CMS repository 103 is connected to or is disposed within a respective server 105 and stores content data of any type, including for example, textual content, such as html content or text files, assets (i.e., file-based assets, embedded assets, images, videos, audio files, etc.), metadata, etc. Generally speaking, the data stored in the CMS repositories 103 may be any data of any type and stored in any organizational manner including structured and unstructured data that may reside in relational and non-relational databases, or any other type of data residing in any other type of storage schema. Moreover, each the content converter 107 may access content data in a CMS repository 103 by using an appropriate CMS connector 114 that is specifically configured for the particular schema of that CMS repository 103 (discussed below).

The content client 115 stores a content editor 120 that communicates with one of the CMS repositories 103 and operates to enable a content manager to create or to edit content data (or individual content items) in the particular CMS repository 103. As illustrated in FIG. 1, the content server 105 may also be connected to and may communicate with one or more application engines 140 through the communication network 125. The application engine 140, which may be stored in a separate server, for example, is connected to the content client 115 through the communication network 125 for example, and may operate to create and store application content data and to communicate this application content data to the CMS repositories 103. Application content data may be any data generated or stored by an application of any type that pertains to, that is associated with, or that is related to content data stored in the CMS repositories 103. The application engine 140 can be stored in external storage attached to the content server 105 or stored within the content server 105. Additionally, there may be multiple application engines 140 that connect to the CMS repositories 103.

The communication networks 125 and 127 may include, but are not limited to, any combination of a LAN, a MAN, a WAN, a mobile, a wired or wireless network, a private network, or a virtual private network. Moreover, while the communication networks 125 and 127 are illustrated separately in FIG. 1 to simplify and clarify the description, it is understood that only one network or more than two networks may be used to support communications with respect to the content clients 115 and the content consumer clients 117. Moreover, while only one content client 115 is illustrated in FIG. 1, it is understood that any number of content clients 115 are supported and can be in communication with the application engine 140.

As indicated above, the CMS repositories 103, which may be stored in or may be separate from the content servers 105, may contain any type of content data that may desired to be displayed, played, utilized, or otherwise consumed by a content consumer. This content data may include, but is not limited to, textual content data, such as html and text files, stand alone and embedded assets, associated metadata that describes or tags the textual content or the asset so that the content may be more easily searched, as well as any other desired types of data. The stand alone or embedded assets may include rich media content, such as videos, images, audio, interactive content, etc., file-based content including portable file documents (pdf), word processing documents, image processing documents, compressed files, or any other asset. Any of the content may be directly stored in a CMS repository 103 or may generated by an application and stored as application generated data. Generally, a content item is stored in a CMS repository 103 as an individual record, an element, a file, or any other type of collection unit or data container and may include multiple and different types of content data, such as an embedded asset (e.g., an image file) and corresponding descriptive metadata for that asset (e.g., metadata describing a file size, a file type, etc. of the associated image file). Each CMS repository 103 may store content data in any organizational structure or schema, including unstructured schemas. For example, a CMS repository 103 may store content data in a structured, unstructured, relational, non-relational database, content management system, or in any other suitable means to stored content data. These types of organizational schemas may be implemented using content management systems, such as Microsoft® SharePoint, Adobe Experience Manager (AEM) including Adobe® CRX™ (application platform natively managing content in a Java Content Repository (JCR 2.0) content model).

Likewise, the content converter engine 109 may access content data stored in the CMS repositories 103 via one or more CMS connectors 114. These CMS connectors 114 may be hardware interfaces, as shown in FIG. 1, or may be implemented via software modules executed by the content converter engine 109. Each CMS connector 114 may be tailored or customized for a particular schema type of a CMS repository 103 so the CMS connector may properly read, access, and retrieve all the types of content data stored with the CMS repository 103. For example, for the content converter engine 109 to access a Microsoft® SharePoint-based CMS repository 103, the content converter engine 109 must implement a Microsoft® SharePoint CMS connector 114 to successfully retrieve content data from that particular CMS repository 103. In turn, a CMS connector 114 with the Adobe® CRX™ type, for example, is configured to access a CMS repository 103 utilizing an Adobe® CRX™ schema. CMS connectors for any type of CMS repository may be implemented utilizing any type of API including JCR-based APIs, Sling based APIs, etc.

The content data can also be accessed by the content editor 120, can be modified, and can be stored back into one or more of the CMS repositories 103. Further, a CMS repository 103 does not need to be physically located within content server 105. For example, the one or more CMS repositories 103 can be placed within a content client 115, can be stored in external storage attached to the content server 105, or can be stored in a network attached storage (not shown). Additionally, there may be multiple content servers 105 that connect to a single CMS repository 103 or a CMS repository 103 may be stored in multiple different or separate physical data storage devices. The content client 115 executes the content editor 120, which operates to allow a user or a content manager to modify the content data stored in the one or more CMS repositories 103, for example, to create a content data, to update content data within the one or more CMS repositories 103 or to associate more information, such as a metadata, with the content data. However, in many cases, content data, including textual content, assets, metadata, application data, etc. may be updated by individuals or particular users in any desired manner.

Furthermore, the CMS repositories 103 may accept and store application-generated data that may be provided by or used in conjunction with the application engine 140. The application-generated data can, for example, be accessed by the application engine 140, modified, and stored back into the CMS repositories 103, or can be generated by the application engine 140 and provided to the CMS repositories 103. The application generated data may be data generated by or used by any type of application, such as a user or mobile device location tracking application, a phone number and address accessing application, etc. As one example, an application implemented by the application engine 140 may aggregate content data for a new product offered on an eCommerce website, such as an online retailer. When a image is uploaded via the application, for example, the application notifies the application engine 140 of the image update. The application engine 140 then updates the application generated data in the appropriate one or more CMS repository 103 indicating a change associated with the new product, namely the updated image. Other types of applications may provide or update the application generated data within the CMS repository 103 with other information associated with the new product, such as a product description of the new product, a price of the new product, physical locations where the new product may be offered, etc.

During operation, the automated content ETL system 101 communicates with the content editing system 100 through the communicative coupling of the content converter 107 (including the content converter engine 109) and the content server 105 via one or more CMS connectors 114. First of all, this communicative coupling allows the content converter engine 109 to automatically retrieve content data, including individual content items, from the CMS repositories 103 and subsequently converting the retrieved content data into a searchable format and then loading the converted content data into the content target 131. This communicative coupling also permits the content server 105 to send a change notification or message that makes the content converter engine 109 aware of a change made to content data stored within the CMS repositories 103. In response to the change notification, the content converter engine 109 may retrieve the content data associated with the change from one or more CMS repositories 103. In another embodiment, the content converter engine 109 may periodically poll the content server 105 to determine whether a change has occurred in one or more of the CMS repositories 103. If a change is discovered, the content converter engine 109 retrieves the content data or content item associated with the change. Alternatively, the content server 105 may propagate the content data or content item associated with the change to the content converter engine 109 in response to polling by the content converter engine 109.

After retrieving content data or content items from a CMS repository 103 via a corresponding and appropriate CMS connector 114, the content converter engine 109 may convert/transform the content data, extract any embedded assets, and load the converted content items and assets into the search platform 133 and/or CDN 135. Beneficially, the content converter engine 109 convert the content data into a format or type that is suitable for the search platform 133 and CDN 135. For example, if the search platform is implemented using Apache Solr™, the content converter engine 109 converts all content data and content items to a format compatible with Solr™. In this manner, the content converter engine 109 advantageously may automatically access content data of all types that is stored in all schemas across multiple CMS repositories 103, convert into a single, uniform schema that is highly searchable via rich metadata, extract any previously difficult to access embedded assets, and load the content data into the searchable search platform 133 and the embedded assets into a CDN 135, for example. This converted content data that is loaded onto the search platform 133 may be further indexed for even quicker and more efficient searching capabilities. Importantly, when a content consumer performs a search, sends a request, or receives content data, none of the CMS repositories is accessed, communicated with, or taxed in any way due to the one-way data-flow nature of this configuration.

Likewise, the content converter engine 109 may also load converted content assets into the CDN 135 for assisting with scalability. The content converter engine 109 may additionally convert the content assets into a format or type that is suitable for the CDN 135 to easily and efficiently replicate content assets on multiple servers and to efficiently serve content assets to the content consumer (i.e. the end user) in response to receiving a request including a unique URI indicating the location of a content asset. The CDN 135 may deliver any received content asset globally using, for example, Akamai NetStorage, or any other suitable CDN 135 system.

In a general scenario, a content manager or any other user may wish to automatically extract, transform, and load content data from one or more CMS repositories 103 into a content target 131 and specifically, into a search platform 133 and CDN 135 of the content target 131. A content editor 120 sends a request (or any other suitable means of sending a request) to the content converter engine 109 to extract, transform, and load content data from one or more CMS repositories 103 to into the content target 131. In response to the request from the content editor 122, the content converter engine 109 retrieves content data from the one or more CMS repository 103 via the one or more CMS connectors 114 that are of the same content management type that corresponds one or more content management types of the CMS repositories 103. In this example, the content converter engine 109 converts or transform the content data from the source-based content managed format or schema into a uniform target-based and searchable schema based on predetermined rules or schemas found in a rule module 110. Moreover, the content converter engine 109 determines whether the content data includes assets embedded within a content item or other piece of content data. In response to the determination that an embedded asset is discovered within a content item, the content converter engine 109 extracts that embedded asset and processes that embedded asset into the uniform target-based and searchable schema based on the rules or schema within the rules module 110 as well.

After all the conversation of all desired content data into the target-based schema, the content converter engine 109 provides, sends, or loads the converted (and possibly extracted) content data into the content target 131. In particular, the content converter engine 109 may send different types of converted or extracted content data to the search platform 133, the CDN 135, or a combination of both. For example, the content converter engine 109 may send all the content data, including extracted assets, to the search platform 133 for indexing and storage. In this example, a content consumer, via a content consumer client 117, may only interact with the search platform 131 in requesting and receiving content data. Alternatively, the content converter engine 109 may send textual content to the search platform 133 for indexing and the assets (extracted or otherwise) to the CDN 135 for serving to the content consumer via one or more CDN servers (e.g., multiple web servers, edge servers, etc.) and via one or more unique URIs. In either example, the content converter engine 109 advantageously allows a content consumer to search, request, and receive content data, originally stored one or more source CMS repositories 103, without accessing or communicating with any of the CMS repositories 103. Moreover, because the content data is loaded onto the search platform 133 and into the CDN 135 and may be appropriately scaled to handle the number of content consumers. Furthermore, this configuration keeps the CMS repositories 103 from being overly taxed and removes the need to scale the CMS repositories 103 at all. Rather, a content consumer may search, request, and receive the content data without accessing or communicating with the CMS repositories 103 at all.

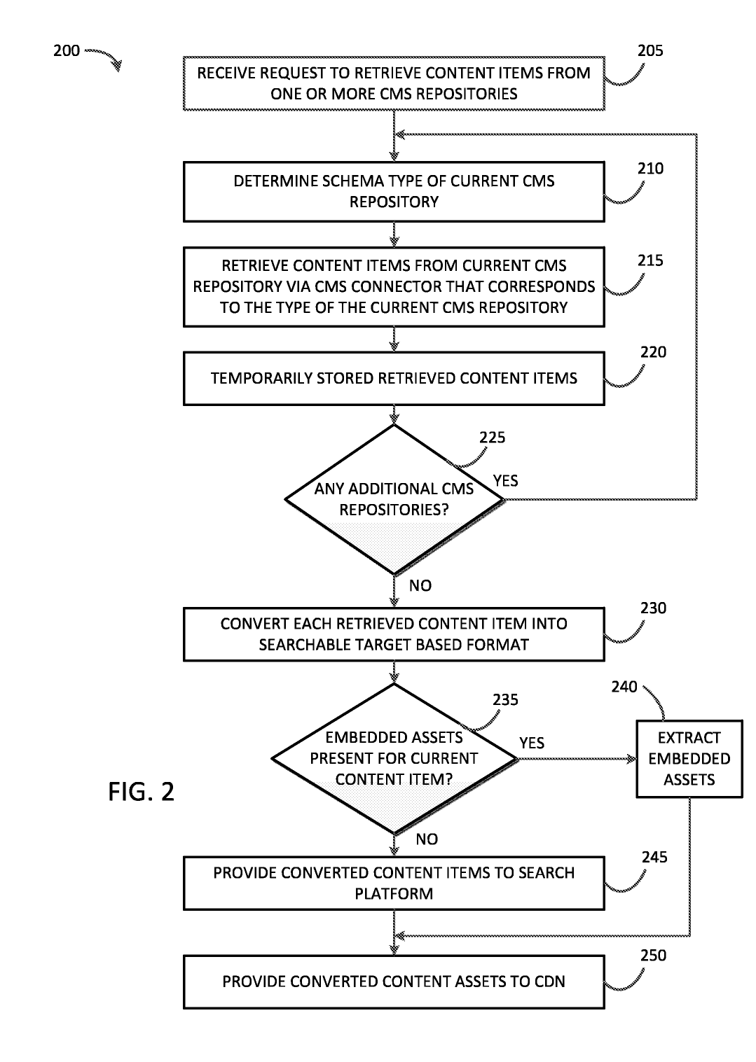

FIG. 2 illustrates a routine or a process flow diagram 200 that may be implemented by the content converter engine 109 of FIG. 1 to receive a request to retrieve content items from one or more CMS repositories 103, convert the content items into a uniform, common searchable format, and provide the converted content items to a searchable platform 133 and a CDN 135. The content converter engine 109 executes routine 200 at a block 205 by receiving a request to retrieve one or more content items from one or more CMS repositories 103.

A block 210 operates to determine a schema, organizational, or structural type of a first or currently selected CMS repository to determine the appropriate CMS connector 114 to utilize. At a block 215, the content converter engine 109 may retrieve content items the currently selected CMS repository using the corresponding or appropriate CMS connector 114. Because the CMS connector 114 is customized or tailored to a particular CMS protocol, the content converter engine 109 may access and retrieve all content data from a CMS repository 103 implemented with the same CMS protocol. As a result, all desired content data is available for retrieval by the content converter engine 109 regardless of the type of content data (e.g., textual content, embedded assets, metadata, etc.) or the structural organization of the content data (e.g., unstructured data, non-relational data, etc.). The content converter engine 109, at a block 220, may temporarily store this retrieved content data within the memory 111 or storage (not shown) of the content converter 107 of FIG. 1. In some implementations, the content converter engine 109 may retrieve all content items from all desired CMS repositories 103 before converting or transforming the content items. Alternatively, the content converter engine 109 may transfer control to a block 230 and convert the retrieved content items as they are retrieved.

In any event, at a block 225, the content converter engine 109 determines whether any additional desired CMS repositories 103 need to be accessed to retrieve additional content items. If more CMS repositories 103 remain to be accessed, the content converter engine 109 may transfer control back to the block 210 to determine the schema type of the next CMS repository 103. If there no CMS repositories 103 remain to be accessed, control is transferred to the block 230. At the block 230, as discussed above, the content converter engine 109 converts the retrieved content items from a source-based format into a target-based format. For instance, if the retrieved content data is tagged with metadata that includes a source-based uniform resource identifier (URI), the content converter engine 109 may convert the metadata for the particular content item into a target-based URI. Alternatively, the retrieved content item may not include any URI at all because of the unstructured nature or organization of the CMS repository 103 from which the particular content item was retrieved. In this alternative example, the content converter engine 109 may create a target-based URI to associate with the unstructured content item.

A block 235 operates to determine the presence of one or more content assets that may be embedded within the content item. In response to the determination that one or more embedded assets exist for the particular content item, the content converter engine 109 may transfer control to a block 240 for extraction. At the block 240, the content converter engine 109 may extract, uncompress, etc. the one or more assets embedded or associated with the content item. Alternatively, if an embedded asset is not discovered at a block 235, the content converter engine 109 may transfer control to a block 245. The content converter engine 109, at the block 245, provides the converted, target-based and searchable content items to the search platform 133. The search platform 133 may create or modify an index to reflect the newly received content item data, including textual data and metadata. Furthermore, in some implementations, the search platform 133 may also receive and store the extracted content assets from the block 240, for example. In turn, the search platform 133 may process search requests using the index and deliver requested content items if internally stored. Otherwise, in an alternative implementation, the search platform 133 may provide search capabilities for a content consumer but then provide the delivery request to a CDN 135. In this alternative example, the content converter engine 109, at a block 250, provides the extracted content assets to the CDN 135 for storage, replication, request processing, and delivery.

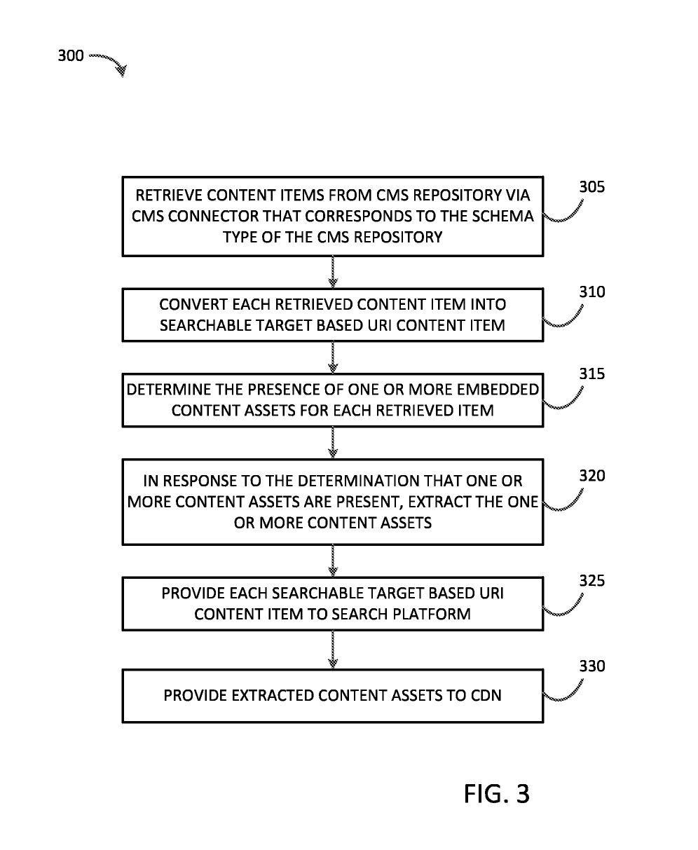

FIG. 3 illustrates a routine or process flow diagram 300 that may be implemented by the content converter engine 109 to receive a request to retrieve content items from one or more CMS repositories 103, convert the content items into searchable target-based URI content items, and provide the searchable target-based URI content items to a searchable platform 133 and a CDN 135. The content converter engine 109 executes routine 300 at a block 305 by retrieving content items from a CMS repository 103 via a CMS connector 114 that corresponds to the schema type of the particular CMS repository 103.

At a block 310, the content converter engine 109 converts each retrieved content item into a searchable target-based URI content item. A block 315 operates to determine the presence of one or more embedded content assets for each retrieved item. In response to the determination that one or more content assets are present, the content converter engine 109, at a block 320, extracts the one or more content assets. At a block 325, the content converter engine 109 provides each searchable target-based URI content item to the search platform 133 and provide the one or more extracted content assets to the CDN 135 at a block 330.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, may comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Still further, the figures depict preferred embodiments of an automated content ETL system for purposes of illustration only. One skilled in the art will readily recognize from the foregoing discussion that alternative embodiments of the structures and methods illustrated herein may be employed without departing from the principles described herein. Thus, upon reading this disclosure, those of skill in the art will appreciate still additional alternative structural and functional designs for a system and a process for automatically extracting, transforming, and loading content data through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A computer-implemented method for automatically providing content items of any type stored within a content management system (CMS) repository to a content consumer via a content delivery network (CDN), the method comprising:
retrieving, via a CMS connector, a plurality of content items from a CMS repository, each content item being of any type and the CMS connector being configured to access each content item of any type stored within the CMS repository;
extracting content and one or more content assets from each retrieved content item;
providing each of the one or more extracted content assets for each content item to at least one CDN for storage, each extracted content asset capable of being retrieved via an unique uniform resource identifier (URI) that indicates the storage location of the particular extracted content asset within the CDN, the CDN configured to provide one or more content assets in response to receiving a corresponding one or more unique URIs without communicating with the CMS repository; and
providing i) the extracted content and ii) the unique URI associated with each of the plurality of retrieved content items to a search platform, the search platform configured to provide content and one or more unique URIs associated with the CDN in response to a consumer initiated content request without communicating with the CMS repository.

2. The method of claim 1, wherein retrieving, via the CMS connector, the plurality of content items from a CMS repository includes retrieving, via a first CMS connector, a first plurality of content items from a first CMS repository, and further comprising:
retrieving, via a second CMS connector, a second plurality of content items from a second CMS repository, each of the second plurality of content items being of any type and the second CMS connector being configured to access each content item of any type stored within the second CMS repository; and
extracting content and one or more content assets from each of the second plurality of retrieved content items.

3. The method of claim 2, wherein the second CMS connector is of a different type than the first CMS connector.

4. The method of claim 3, wherein the first CMS connector is configured only to receive content items from the type of CMS repository associated with the first CMS repository, and the second CMS connector is configured only to receive content items from the type of CMS repository associated with the second CMS repository.

5. The method of claim 1, wherein the content includes textual content and metadata.

6. The method of claim 5, wherein the search platform is configured to provide content and one or more unique URIs by issuing the consumer initiated content request against a search index of the search platform based on the textual content and the metadata.

7. The method of claim 5, wherein i) the textual content includes at least one of html content, embedded textual content, or mark-up language content, and i) the metadata describes at least one of associated textual content or associated content assets.

8. The method of claim 5, wherein the one or more content assets includes at least one of an image file, a video file, an audio file, a portable document file, a word processing document file, a compressed file, or a web-based file.

9. The method of claim 1, wherein the CMS repository includes at least one of a relational database, non-relational database, or a cloud-based content management system.

10. The method of claim 1, wherein the content items stored in the CMS repository include content items that are of an unstructured, media oriented type that the CMS connector is configured to access.

11. A computer-readable medium having instructions stored thereon and executable by one or more processors to perform a method of automatically providing content items of any type stored within a content management system (CMS) repository to a content consumer via a content delivery network (CDN), the method comprising:
retrieving, via a CMS connector, a plurality of content items from a CMS repository, each content item being of any type and the CMS connector being configured to access each content item of any type stored within the CMS repository;
retrieving, via a CMS connector, a plurality of content items from a CMS repository, each content item being of any type and the CMS connector being configured to access each content item of any type stored within the CMS repository;
extracting content and one or more content assets from each retrieved content item;
providing each of the one or more extracted content assets for each content item to at least one CDN for storage, each extracted content asset capable of being retrieved via an unique uniform resource identifier (URI) that indicates the storage location of the particular extracted content asset within the CDN, the CDN configured to provide one or more content assets in response to receiving a corresponding one or more unique URIs without communicating with the CMS repository; and
providing i) the extracted content and ii) the unique URI associated with each of the plurality of retrieved content items to a search platform, the search platform configured to provide content and one or more unique URIs associated with the CDN in response to a consumer initiated content request without communicating with the CMS repository.

12. The computer readable medium of claim 11, wherein retrieving, via the CMS connector, the plurality of content items from a CMS repository includes retrieving, via a first CMS connector, a first plurality of content items from a first CMS repository, and the method further comprising:
retrieving, via a second CMS connector, a second plurality of content items from a second CMS repository, each of the second plurality of content items being of any type and the second CMS connector being configured to access each content item of any type stored within the second CMS repository; and
extracting content and one or more content assets from each of the second plurality of retrieved content items.

13. The computer readable medium of claim 12, wherein the second CMS connector is of a different type than the first CMS connector.

14. The computer readable medium of claim 13, wherein the first CMS connector is configured only to receive content items from the type of CMS repository associated with the first CMS repository, and the second CMS connector is configured only to receive content items from the type of CMS repository associated with the second CMS repository.

15. The computer readable medium of claim 11, wherein the extracted content includes textual content and metadata.

16. The computer readable medium of claim 15, wherein the search platform is configured to provide content and one or more unique URIs by issuing the consumer initiated content request against a search index of the search platform based on the textual content and the metadata.

17. The computer readable medium of claim 15, wherein i) the textual content includes at least one of html content, embedded textual content, or mark-up language content, and i) the metadata describes at least one of associated textual content or associated content assets.

18. The computer readable medium of claim 15, wherein the one or more content assets includes at least one of an image file, a video file, an audio file, a portable document file, a word processing document file, a compressed file, or a web-based file.

19. The computer readable medium of claim 11, wherein the CMS repository includes at least one of a relational database, non-relational database, or a cloud-based content management system.

20. A system for automatically providing content items of any type stored within a content management system (CMS) repository to a content consumer via a content delivery network (CDN) comprising:
a CMS connector capable of being communicatively coupled to a CMS repository;
a content convertor communicatively coupled to the CMS connector and configured to:
retrieve, via a CMS connector, a plurality of content items from a CMS repository, each content item being of any type and the CMS connector being configured to access each content item of any type stored within the CMS repository,
extract content and one or more content assets from each retrieved content item,
provide each of the one or more extracted content assets for each content item to at least one CDN for storage, each extracted content asset capable of being retrieved via an unique uniform resource identifier (URI) that indicates the storage location of the particular extracted content asset within the CDN, the CDN configured to provide one or more content assets in response to receiving a corresponding one or more unique URIs without communicating with the CMS repository, and
provide i) the extracted content and ii) the unique URI associated with each of the plurality of retrieved content items to a search platform, the search platform configured to provide content and one or more unique URIs associated with the CDN in response to a consumer initiated content request without communicating with the CMS repository.
